(19) United States
(12) Patent Application Publication
(10) Pub. No.: US 2016/0344941 A1
(43) Pub. Date: Nov. 24, 2016

(54) METHOD AND DEVICE FOR CONTROLLING THE ZOOM OF AN IMAGE-CAPTURING APPARATUS

(71) Applicant: MOVE'N SEE, Plouzane (FR)

(72) Inventors: Remy CARPENTIER, BREST (FR); Eric WILLEMENOT, PLOUZANE (FR)

(73) Assignee: MOVE'N SEE, Plouzane (FR)

(21) Appl. No.: 15/112,807

(22) PCT Filed: Jan. 19, 2015
(86) PCT No.: PCT/EP2015/050828

§ 371 Date: Jul. 20, 2016

(30) Foreign Application Priority Data
Jan. 21, 2014 (FR) 14 50499

(51) Int. Cl. H04N 5/232; H04N 17/00

(52) U.S. Cl. CPC H04N 5/23296; H04N 5/23241; H04N 17/002

(57) ABSTRACT

A method for controlling the zoom of an image-capturing apparatus, noteworthy in that it includes a step in which a controlling device (11) sends a burst of successive zoom commands over a series link (13) of the image-capturing apparatus (12), the number of commands making up the burst being included between 5 and 120 and the time between two bursts being longer than 100 ms and in that it includes a step of arresting the zoom mechanism if the number of bursts has reached a first predetermined limit value.

### TECHNICAL FIELD AND PRIOR ART

The present invention relates to a method and device for controlling the zoom of an image-capturing apparatus. A zoom is an objective of variable focal length (video camera, still camera). The automatic control is here of apparatuses equipped with an input allowing them to be controlled remotely, possibly for example via infrared or more specifically an asynchronous bidirectional series link providing no feedback on the state of the zoom (which is interchangeably denoted zoom or focal length) either by image analysis or by an electromechanical device or by any other feedback principle.

Zoom protocols such as the Local Application Control Bus System (LANC) protocol exist. These protocols allow commands to be sent to a video camera in order to increase or decrease the zoom i.e. to increase or decrease the focal length of the objective, respectively. However, these protocols do not allow for feedback of the focal length of the objective.

Document US2013278778 describes a system for automatically controlling a zoom, based on an image analysis. This document allows for feedback of the zoom state by virtue of the image analysis, and therefore does not allow the problem of zoom control without feedback, which could exhibit deviations and drifts between the focal length of the objective and the commanded zoom, to be solved.

Since in the LANC protocol no feedback is possible on the focal length of the objective, the actual focal length may drift relative to the commanded focal length. Without feedback from the video camera on the focal length of the objective, and without analysis of the filmed images, zoom errors, of which the controlling device has no knowledge and therefore cannot correct, may occur.

For example, if the zoom is satisfactory at a given instant (either because the user has adjusted it himself and therefore added information to the automatic device, or because the zoom is in abutment with a stop; stop the zoom characteristics of which are known and always identical), the commands to zoom more or less are produced automatically depending on the distance of the subject to be filmed, which distance is determined by measuring means that are not the subject of this document and which may be a signal issued from a geo-positioning system such as a Global Positioning System (GPS®), from electromagnetic means, from optical means, from laser means, from ultrasonic means, inter alia. After a certain length of time, it is possible for the focal length of the objective to deviate from the sent command. Since the automatic system is unaware of this deviation between the focal length of the objective, the actual zoom, and the commanded focal length represented by the sent command, it cannot correct it.

With the SONY (registered trademark) PJ740 mass-market video camera for example, after only four there-and-back trips of the zoom between two values close to the upper and lower stops, controlled according to the LANC protocol via a cable provided for this purpose, the value of the zoom may have varied by 29% (a focal length of 5.34 mm has become 6.88 mm). During another trial the same zoom commands generated a different shift in focal length, for example 5.34 mm and 5.72 mm (i.e. 7%). There is therefore a deviation relative to the sent command. In addition, this deviation is not reproducible from one trial to the next.

This is a substantial limitation on the automatic control of video-camera zooms via the methods described above. Specifically, after a length of time of only a few minutes, a subject filmed automatically may be imaged with a focal length that is not the desired focal length and this may mean that the image is too large (lack of visibility of the subject relative to that desired) or too small (subject not completely visible on the screen, and/or off the screen if he is not placed centrally enough in the latter).

### DESCRIPTION OF THE INVENTION

The present invention aims to remedy all or some of these drawbacks.

To this end, the present invention relates, according to a first aspect, to a method for controlling the zoom of an image-capturing apparatus, which comprises: a step in which a controlling device sends a burst of successive zoom commands over a series link of the image-capturing apparatus, the number of commands making up the burst being comprised between 5 and 120 and the time between two bursts being longer than 100 ms; and a step in which the zoom mechanism is brought into abutment with a stop if the number of bursts has reached a first predetermined limiting value.

The expression “successive commands” is understood to mean juxtaposed commands.

The inventors have discovered that successions of commands in bursts decrease the drift in the focal length of the image-capturing apparatus.

By image-capturing apparatus what is meant is any apparatus having an automatic image-framing device and/or an image-framing device controlled manually by an operator.

The invention is advantageously implemented according to the embodiments described below, which are to be considered individually or in any technically possible combination.

By virtue of this arrangement, stops being mechanically well known, the system is able to reset itself mechanically.

The second predetermined limiting value is motivated by the desire not to too often see the quality of recorded images degraded, in the context of wide-angle images, by a “violent” and extreme de-zoom, the trade-off being that a higher zoom drift must be tolerated since the system is reset less often.

According to some embodiments, the stop-abutment step is carried out if the number of successive zoom commands has reached a second predetermined limiting value, when images are being captured by the image-capturing apparatus.

According to some embodiments, the method includes a step in which a first predetermined value depending on a residual drift measured when the step in which the zoom mechanism is brought into abutment with a stop is not implemented is stored in memory.

By residual drift, what is meant is the observed deviation between the image and what would be expected from all the commands sent since turn on of the image-capturing system, when the stop-abutment method is not implemented. A nonzero residual drift means that a focal length is observed that is longer or shorter than the focal length expected from the sent commands. The residual drift is measured in a test that consists in applying zoom commands in bursts such as described above, to the image-capturing device. These bursts increase the zoom to a level close to the upper stop while ensuring it is not reached, then lower the zoom toward the lower stop while ensuring it is not reached, then re-increase the zoom and so on over ten there-and-back trips. During this test, the operator or any other control means will modify the direction of the zoom so that the zoom level actually observed (for example on a test pattern) never reaches the stops.

According to some embodiments, the first predetermined limiting value is a number of bursts lower than the number of bursts without resetting that causes a residual drift of 30% in the focal length, the second predetermined limiting value is a number of bursts lower than the number of bursts without resetting that causes a residual drift of 40% in the focal length, and the second predetermined limiting value is higher than the first predetermined limiting value.

To remove any ambiguity from the preceding paragraph we give the following by way of example: if it is desired to limit the drift in focal length to a value of 5%, the first limiting value of the number of bursts will be chosen to be lower than if it is desired to limit the drift to 30%. Likewise, to achieve these values of 5%, the second limiting value of the number of bursts will be chosen to be lower than if it is desired to limit the drift to 40%.

The first predetermined limiting value is calculated with the aim of being used when the video camera is not recording. In this case it is possible to permit more frequent stop abutments since this is not seen in the video recordings. The second predetermined limiting value is calculated with the aim of being used during recording.

The aim of this embodiment is to obtain a small enough drift in focal length to preserve a good visibility of the filmed subject, the latter appearing neither too large nor too small in the image.

According to some embodiments, one or more zoom bursts are sent to the image-capturing apparatus by the controlling device depending on information on the distance of the subject to be filmed relative to the image-capturing device.

If the subject to be filmed moves away, i.e. increases his distance, one or more bursts will be sent in order to increase focal length. If the subject moves closer, one or more bursts will be sent in order to decrease focal length.

According to some embodiments, one or more zoom bursts are sent to the image-capturing apparatus by the controlling device depending on information on the vertical acceleration of the subject to be filmed.

When the controlling device has at its disposal information on the altitude of the subject to be filmed, it is judicious to take advantage of this information to decrease focal length when a sufficient vertical acceleration is detected. This may allow the image-capturing device to capture more advantageous images if the subjects to be filmed jump or descend or fall rapidly, by allowing a larger field of view to be viewed, favoring perception of the movements of the subject to be filmed by the spectator.

A burst for decreasing focal length is applied for a vertical acceleration higher than a predetermined limit. This predetermined limit is higher than or equal to 2 m·s⁻².

According to some embodiments, the number of successive zoom commands in a burst is different depending on whether it is a question of increasing the zoom or of decreasing the zoom. The difference between the two directions is a number of successive commands comprised between 0 and 115. The inventors have discovered that with certain image-capturing apparatuses the drift in focal length is larger when the zoom is increased than when it is decreased, or vice versa.

According to some embodiments, the number of successive zoom commands in a burst is a pseudo-random number between 5 and 120. The inventors have discovered that by averaging the residual drifts in the zoom, the residual drift is decreased. On each burst, or after a certain number of bursts, the number of successive zoom commands that make up a burst changes pseudo-randomly. The appearance of the images taken by the image-capturing device is thus more like that of images taken by a human operator.

According to some embodiments, the number of successive zoom commands in a burst depends on the voltage of the battery supplying power to the image-capturing device, said number being an increasing function adding between 0 and 10 zoom commands per tenth-of-volt decrease in the voltage.

This may make it possible to compensate for a dependence of the modification of the focal length during a burst on battery voltage.

According to another embodiment, the invention relates to a zoom-controlling device for an image-capturing apparatus, the device comprising an image-capturing apparatus and a zoom-controlling means connected by a series link to the image-capturing apparatus and implementing the method.

### BRIEF DESCRIPTION OF THE FIGURES

Other features and advantages of the invention will become apparent in light of the following description, which is given based on the appended drawings. These examples are nonlimiting. The description is to be read with regard to the appended drawings, in which:

FIG. 1 shows a schematic view of an exemplary embodiment of a device according to the invention;

FIG. 2 shows an example of a transmission frame sent between a controlling device and an image-capturing device;

FIG. 3 shows an overview of an example in which a number of successive zoom commands are sent in transmission frames to remotely control an image-capturing apparatus;

FIG. 4 shows, in the form of a flowchart, steps of one particular embodiment of the method according to the invention; and

FIG. 5 shows, in the form of a flowchart, steps of one particular embodiment of the method according to the invention.

### DESCRIPTION OF EMBODIMENTS OF THE INVENTION

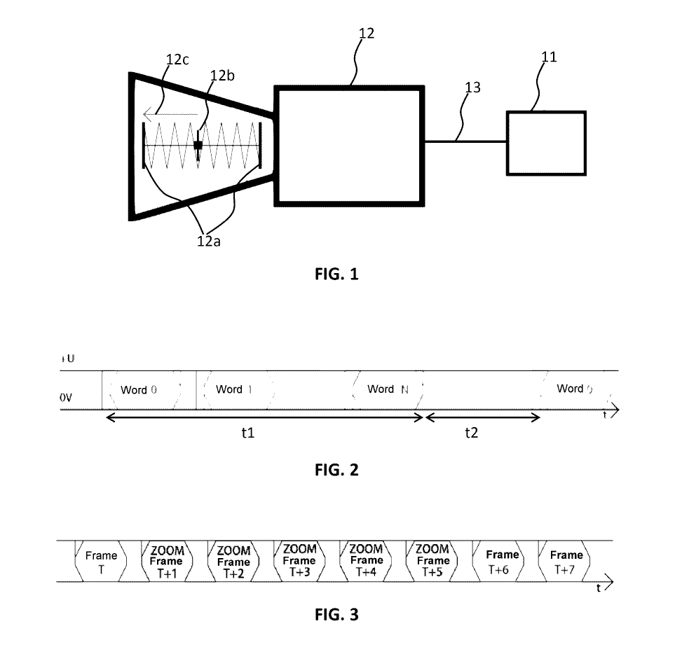

FIG. 1 shows, according to one exemplary embodiment, a controlling device 11, an asynchronous bidirectional series link 13 and an image-capturing apparatus 12.

The method is based on the transmission of successive zoom commands, or in other words commands in bursts, over the asynchronous bidirectional series link (i.e. the remote-control input) of the image-capturing apparatus.

The method resets the focal length of the objective. This method consists in, as shown by the arrow 12c, bringing the internal zoom mechanism 12b of the image-capturing device 12 into abutment with one of two mechanical stops 12a.

Once the successive commands have been sent, the controlling device 1 knows the physical state of the zoom and correspondingly modifies its internal representation.

For example, with an image-capturing apparatus that exhibits a focal-length error of 28% after 200 bursts, the implementation of commands such as described in the method divides by four deviations in the focal length.

In this example, the values of 28% were measured in the following way for a given model of video camera: 200 bursts separated in time from one another by 100 ms were sent, while changing the direction of the zoom every 5 bursts, the value at turn on being 1.5 times the lower focal length (the lower focal length is 300 mm and the initial value is 45 mm), and the direction of the bursts being such as to increase focal length. Each burst comprises in this example 30 successive commands.

Without the reset command, the deviation between the commanded lower value and the mechanical stop will be larger than the residual error allowed by the implemented method, and the deviation between the upper commanded value and the upper stop will be larger than the residual error allowed by the method implemented.

In one exemplary image-capturing apparatus, the minimum commandable focal length is 5.3 mm whereas the minimum optical focal length is 3.8 mm.

The residual drift is not set and is considered to be random. The first predetermined limiting value (denoted A) and the second predetermined limiting value (denoted B) are chosen by measuring the worst case of residual drift after a few tens or hundreds of bursts, precautions having been taken to ensure that these bursts do not bring the zoom into abutment with a stop.

According to one exemplary embodiment, the method is carried out after an image-capturing sequence has finished.

According to one exemplary embodiment, the first predetermined limiting value and the second predetermined limiting value are calculated in the laboratory in order to be loaded into a controlling device.

To maintain a residual drift below a fraction 1/X of a zoom burst under the conditions of use (during recording) of the image-capturing apparatus, we will for example choose B=1/X*(number of zoom commands creating one burst of residual drift)/(number of zoom commands in one burst).

Numerical example: it is reasonable to seek a half-burst of residual error after the implementation of the resetting method, i.e. X=2. With bursts that are 45 zoom commands in size, it has been observed that 5000 zoom commands sometimes produce as much as one burst of error between the command sent by the controlling device and the image observed during laboratory tests. From the above formula the value of B: B=½*(5000)/45=55, is deduced.

Therefore, when the image-capturing device is being used (for example the video camera is recording), the controlling device sends a reset signal every 55 bursts. Since the image-capturing device is recording, this reset signal will be seen in the recorded images.

When the image-capturing device is not recording images, it is judicious, for an even smaller residual error, to reset the zoom more often since nothing will be seen in the recorded images. For example A=37 will be chosen if it is desired to obtain at most ⅓ of a burst of residual error, or indeed A=27 if at most ¼ of a burst of residual error is desired, and so on.

The first predetermined limiting value and the second predetermined limiting value are stored in the controlling device. According to one example, the controlling device comprises a database including a plurality of first predetermined limiting values and a plurality of second predetermined limiting values. This database contains values for various models of image-capturing apparatus.

It may be seen in FIG. 2 that, according to one example of a transmission frame sent between a controlling device and an image-capturing apparatus, the asynchronous bidirectional series link always contains transmission frames, i.e. exchanges of data between the image-capturing apparatus and the controlling device. The time t1 represents a duration of a transmission frame T comprising several words. The time t2 represents a time between two transmission frames, during which time no words are sent, this corresponding to a pause. Some of the words of the frame relate to zoom commands from the controlling device, which sends them to the image-capturing device.

FIG. 3 shows an overview of an example in which a number of successive zoom commands are sent in transmission frames to remotely control an image-capturing apparatus. The period of the transmission frames is for example 16.6 ms or 20 ms.

In this example, the zoom command comprises five successive zoom commands. Before this command, therefore before the transmission frame number T, and after this zoom command, therefore after the transmission frame number T+5, at least 100 ms passes without a burst being sent, i.e. the transmission frames exist but contain no bursts.

The fact that the zoom commands are sent in succession ensures the zoom is well regulated. Conventionally, zoom commands are not necessarily successive and this may lead to a substantial deviation between the sent zoom command and the actual zoom.

Said method allows the tracking of a subject by a video camera (image-capturing apparatus) mounted on a motorized ball-and-socket head and automatically controlled so as to always point in the direction of the target to be made more effective. Specifically, by integrating the method into such a device, the width of the frame may also be automatically controlled and a rendering close to the rendering that a human would obtain produced.

Thus, the method allows the zoom of a commercially available video camera or movie camera provided with a remote-control input, and especially an input for a remote control based on the Local Application Control Bus System (LANC) protocol, to be effectively controlled.

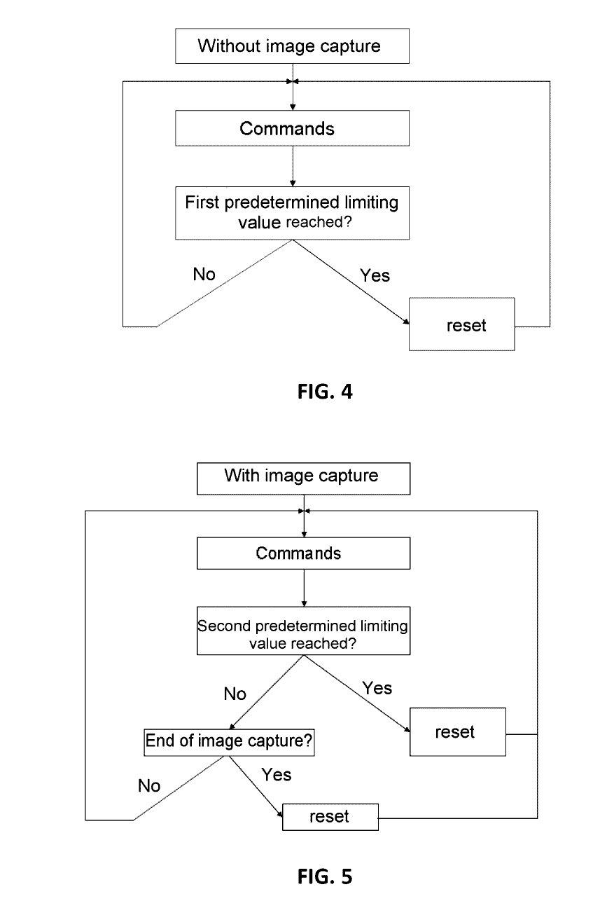

FIG. 4 shows a flowchart of an exemplary embodiment of the invention. The first step considers that the image-capturing apparatus is not in image-capturing mode. The second step sends successive zoom commands. The third step interrogates the controlling device to determine whether the first predetermined limiting value has been reached. If the response is yes, then a reset is performed and if the response is no, then a zoom command is transmitted.

FIG. 5 shows a flowchart of one exemplary embodiment of the invention. The first step considers that the image-capturing apparatus is in image-capturing (image-recording) mode. The second step sends successive zoom commands. The third step interrogates the controlling device to determine whether the second predetermined limiting value has been reached. If the response is yes, then a reset is performed. If the response is no, there is new interrogation on the end of the image capturing of the image-capturing apparatus. If the response is yes, then a reset is performed. If the response is no, then new successive zoom commands may be sent.

1. A method for controlling the zoom of an image-capturing apparatus, which comprises:
a step in which a controlling device (11) sends a burst of successive zoom commands over a series link (13) of the image-capturing apparatus (12), the number of commands making up the burst being comprised between 5 and 120 and the time between two bursts being longer than 100 ms; and
a step in which the zoom mechanism is brought into abutment with a stop if the number of bursts has reached a first predetermined limiting value.

2. The method as claimed in claim 1, wherein the stop-abutment step is carried out if the number of bursts has reached a second predetermined limiting value, when images are being captured by the image-capturing apparatus (12).

3. The method as claimed in claim 2, wherein the method includes a step in which a first predetermined limiting value or a predetermined limiting value depending on a residual drift measured when the subject matter of the step in which the zoom mechanism is brought into abutment with a stop is not implemented is stored in memory.

4. The method as claimed in claim 3, wherein the first predetermined limiting value is a number of bursts lower than the number of bursts without resetting that causes a residual drift of 30% in the focal length, the second predetermined limiting value is a number of bursts lower than the number of bursts without resetting that causes a residual drift of 40% in the focal length, and the second predetermined limiting value is higher than the first predetermined limiting value.

5. The method as claimed in claim 1, wherein one or more zoom bursts are sent to the image-capturing apparatus (12) by the controlling device (11) depending on information on the distance of the subject to be filmed relative to the image-capturing device.

6. The method as claimed in claim 1, wherein one or more zoom bursts are sent to the image-capturing apparatus (12) by the controlling device (11) depending on information on the vertical acceleration of the subject to be filmed.

7. The method as claimed in claim 1, wherein the number of successive zoom commands in a burst is different depending on whether it is a question of increasing the zoom or of decreasing the zoom, the difference between the two directions being a number of successive commands comprised between 0 and 115.

8. The method as claimed in claim 1, wherein the number of successive zoom commands in a burst is a pseudo-random number between 5 and 120.

9. The method as claimed in claim 1, wherein the number of successive zoom commands in a burst depends on the voltage of the battery supplying power to the image-capturing device (12), said number being an increasing function adding between 0 and 10 zoom commands per tenth-of-volt decrease in the voltage.

10. A zoom-controlling device for an image-capturing apparatus, which comprises an image-capturing apparatus and a zoom-controlling means connected by a series link to the image-capturing apparatus and implementing the method as claimed in claim 1.

11. The method as claimed in claim 2, wherein one or more zoom bursts are sent to the image-capturing apparatus (12) by the controlling device (11) depending on information on the distance of the subject to be filmed relative to the image-capturing device.

12. The method as claimed in claim 2, wherein one or more zoom bursts are sent to the image-capturing apparatus (12) by the controlling device (11) depending on information on the vertical acceleration of the subject to be filmed.

13. The method as claimed in claim 2, wherein the number of successive zoom commands in a burst is different depending on whether it is a question of increasing the zoom or of decreasing the zoom, the difference between the two directions being a number of successive commands comprised between 0 and 115.

14. The method as claimed in claim 2, wherein the number of successive zoom commands in a burst is a pseudo-random number between 5 and 120.

15. The method as claimed in claim 2, wherein the number of successive zoom commands in a burst depends on the voltage of the battery supplying power to the image-capturing device (12), said number being an increasing function adding between 0 and 10 zoom commands per tenth-of-volt decrease in the voltage.
